(19) United States
(12) Patent Application Publication
(10) Pub. No.: US 2026/0112628 A1
(43) Pub. Date: Apr. 23, 2026

(54) Hard Carbon with Sieving Closed-pore Structure as Anode Material for Sodium-ion Battery

(71) Applicants: Qi Xue, Shenzen (CN); Zhou Fang, Shenzen (CN); Jing Xiang, Hong Kong (HK); Zhong Zheng, Shenzheng (CN); Bin Zhu, Shenzhen (CN)

(72) Inventors: Qi Xue, Shenzen (CN); Zhou Fang, Shenzen (CN); Jing Xiang, Hong Kong (HK); Zhong Zheng, Shenzheng (CN); Bin Zhu, Shenzhen (CN)

(21) Appl. No.: 18/923,688

(22) Filed: Oct. 23, 2024

(51) Int. Cl. H01M 4/583; H01M 4/02; H01M 4/04; H01M 4/1393

(52) U.S. Cl. CPC H01M 4/583; H01M 4/0471; H01M 4/1393; H01M 2004/021; H01M 2004/027

(57) ABSTRACT

Hard carbon with sieving closed-pore structure and its preparation method are disclosed. Biomass mixture such as cotton, farm biowaste, or a mixture with 70-90% cellulose, 9-20% hemicellulose, and 1-10% lignin, etc., is applied as the raw material. This mixture is subjected to calcination at temperatures ranging from 300 to 600° C., resulting in a pre-carbonized precursor. The precursor is then washed with an alkaline solution. Finally, the precursor undergoes a second calcination at a temperature between 900 to 1400° C. to yield the hard carbon product with sieving closed-pore structure.

### BACKGROUND OF THE INVENTION

The invention relates to hard carbon with sieving closed-pore structure and its fabrication method.

In recent years, sodium-ion batteries (SIBs) have gained significant attention as a promising alternative to lithium-ion batteries, particularly due to the abundant and widespread availability of sodium. However, the performance of SIBs depends heavily on the quality of the anode material, which must accommodate the larger ionic radius of sodium compared to lithium and permit rapid ion transport.

Hard carbon is widely used as active anode material in SIBs. Due to the low price, hard carbon is the best choice for the anode of SIBs. The structure of hard carbon includes a short carbon chain, a highly disordered structure, a long layer distance, and a closed-pore structure. Hard carbon is a form of non-graphitic carbon that is recognized for its amorphous structure with a degree of short-range order. This structure is particularly beneficial for energy storage applications due to its ability to host sodium ions.

Traditionally, hard carbon derived from various carbon sources has been utilized as an anode material for SIBs, but the lack of control over pore structure often leads to suboptimal electrochemical performance. Pore structure plays a needed role in facilitating sodium ion diffusion and accommodating the volume changes during the charging and discharging cycles.

### SUMMARY OF THE INVENTION

In one aspect, hard carbon characterized by sieving closed-pore structure could provide surface and inner space, the structure further having a window to receive sodium during charging, wherein the sodium ion passes through the window and absorbs on the surface and occupies the inner space after charging.

In another aspect, a method is disclosed for the production of hard carbon. This method comprises a two-step heat treatment (calcining) of a biomass mixture under specific conditions to achieve desirable physical and chemical characteristics of the hard carbon product. Hard carbon with sieving closed-pore structures are formed by: calcining a biomass mixture having 70-90% cellulose, 9-20% hemicellulose, and 1-10% lignin at a temperature between 300-600° C. to produce a pre-carbonized precursor; rinsing the pre-carbonized precursor with an alkali solution to adjust the pH to 6.0-8.0; and re-calcining the pre-carbonized precursor at a temperature between 900-1400° C. to produce a sieving closed-pore hard carbon.

In a further aspect, an anode for a sodium-ion battery includes a hard carbon material characterized by sieving closed-pore structure.

In yet another aspect, a sodium-ion battery includes a cathode; an electrolyte coupled to the cathode; and an anode coupled to the electrolyte, the anode having a plurality of sieving close-pore structures.

Implementations of the above aspects can include one or more of the following. The biomass mixture can be organic materials that are rich in carbon content. The biomass mixture serves as a precursor, which undergoes a heat treatment process or calcining. The calcining step enables the organic components of the biomass to be thermally decomposed to yield a carbon structure. The process of calcining is conducted in an inert atmosphere to prevent the oxidation of the carbonaceous material. The precursor is subjected to a temperature of 300-600° C. The temperature treatment is carried out with a ramping rate under inert gas at 2-10° C./min. This treatment leads to an initial decomposition and carbonization of the biomass. Following this, the material is washed by an alkali solution with a concentration between 0.05-1.0 mol/L to clean and activate the carbon surface. The second heat treatment is extended to a higher temperature of 900-1400° C. The temperature has a ramp rate of 2-10° C./min in an inert gas atmosphere. During this re-calcination step further development of the hard carbon structure occurs as any remaining volatile materials are eliminated, enhancing the porosity of the hard carbon material. The resultant hard carbon material exhibits an optimized structure for the reversible insertion and extraction of sodium ions, resulting in high-performance SIBs.

Advantages of the material may include one or more of the following. This method leverages the inherent structure of biomass, consisting of cellulose, hemicellulose, and lignin, to create a hard carbon precursor with a desirable pore framework upon calcination. By optimizing the calcination temperatures and employing post-processing rinsing and re-calcination steps, a hard carbon material is fabricated that possesses sieving closed-pore structure, predominantly with a target pore size distribution. This structure not only facilitates rapid ion transport but also provides structural integrity, enhancing the cycling stability of sodium-ion batteries. The method uses biomass as the starting material in a sustainable and cost-effective approach, given the biomass' natural abundance and renewable nature. The method recycles agricultural waste which promotes a greener manufacturing process while also addressing waste management issues. The biomass mixture employed in the disclosed method is sourced from agricultural waste, which provides an abundant and renewable feedstock for the production of hard carbon anode materials for sodium-ion batteries. By utilizing agricultural waste, the method not only offers a sustainable approach to battery manufacturing but also contributes to the management and reduction of agricultural waste, closing the loop in the agricultural lifecycle and promoting eco-friendly practices.

Another advantage is that an optimized structure for sodium storage is created, allowing for the development of sodium-ion batteries with improved capacity, rate performance, and cycling stability. This approach, therefore, represents a significant advancement in the design and synthesis of anode materials for next-generation energy storage technologies. The hard carbon, produced through a carefully controlled process of biomass calcination and chemical treatment, possesses sieving closed-pore structure well suited as an anode material in sodium-ion batteries. Such a configuration has been found to be highly beneficial for the electrochemical performance of the material, specifically in regard to the kinetics of Na⁺ ion insertion and extraction.

In other advantages, the method creates hard carbon with sieving closed-pore structure. The hard carbon material presents high surface area, proper pore distribution, and electrical conductivity which are key properties for achieving fast charge-discharge rates and high energy densities in batteries. These characteristics make the sieved closed-pore hard carbon an exemplary candidate for advanced energy storage applications, thereby aligning with the increasing demand for renewable energy solutions and the transition towards more sustainable energy storage technologies.

### BRIEF DESCRIPTION OF DRAWINGS

FIG. 1 shows TEM image of the hard carbon in this invention and the illustration of a sodium layer dispersion after charging.

FIG. 2 shows exemplary XRD patterns of three hard carbon samples produced using the instant method.

FIG. 3 shows exemplary Rama spectra patterns for three hard carbon samples produced using the instant method.

FIG. 4 shows exemplary TEM images for three hard carbon samples produced using the instant method.

FIG. 5 shows exemplary SIB performance curves.

### DETAILED DESCRIPTION OF THE INVENTION

The present disclosure relates to hard carbon characterized by sieving closed-pore structure and a method to fabricate the mentioned hard carbon derived from a biomass mixture for use in sodium-ion batteries. This method optimizes the pore structure within the hard carbon to enhance Na⁺ ion insertion, improving the storage capacity and efficiency of the batteries.

To obtain the desired hard carbon structure, suitable carbon-rich biomass is selected and prepared to ensure a high yield of carbon upon processing. To prepare the biomass mixture, agricultural residues, which are otherwise considered to be by-products or waste from farming activities, are gathered. These may include but are not limited to, plant stalks, leaves, husks, shells, and other organic matter that is rich in cellulose. This material is initially processed, often through drying and grinding, to achieve a consistent particle size and homogenization for uniform calcination and chemical reactions throughout.

The biomass is processed through a series of thermal and chemical treatments to transform it into hard carbon with properties conducive to energy storage in sodium-ion batteries. In one example, the biomass mixture is comprised of cellulose, hemicellulose, and lignin in proportions conducive to the effective conversion into hard carbon. Specifically, the cellulose content ranges from 70% to 90%, serving as the primary carbon source. Hemicellulose, a structural polysaccharide found in plant cell walls akin to cellulose, is present in an amount of 9% to 20%. Lignin, an organic polymer that provides structural support to vascular plants and some algae, makes up 1% to 10% of the mixture. This specified composition ensures that the requisite properties for hard carbon formation are met, and that the resulting material possesses the desired characteristics for electrochemical applications.

The above biomass mixture contains from 70-90% cellulose, 9-20% hemicellulose, and 1-10% lignin. The biomass mixture undergoes an initial calcination at 300-600° C., resulting in a precursor characterized by cellulose as a carbon chain, hemicellulose as a short carbon chain and pore structure, and lignin/other providing the pore structure. The precursor is then subjected to an alkaline with a concentration between 0.05-1.0 mol/L washing step then neutralize to pH of 6.0-8.0.

Following this, a second calcination step is performed at 900-1400° C. to produce the desired sieving closed-pore hard carbon. The resulting hard carbon is suitable for use as an anode material in sodium-ion batteries.

Upon acquisition of the biomass mixture, the process proceeds to the calcination of the mixture at a temperature controlled within the range of 300° C. to 600° C. The calcination process induces thermal decomposition of the organic constituents in the biomass, facilitating the conversion of biomaterial into a pre-carbonized state. This precursor state denotes an intermediate step in the synthesis of hard carbon where the biomass has undergone substantial chemical changes due to heat exposure without reaching a fully carbonized stage.

Following calcination, the pre-carbonized precursor generated from the biomass mixture is subjected to a rinsing phase. An alkali solution is employed for rinsing purposes to neutralize any residual acidic compounds that may be present within the pre-carbonized precursor and generate closed-pore structure. This process serves to purify the precursor and to optimize its chemical environment for subsequent conversion into hard carbon.

Treatment with alkali prepares the hard carbon structure for efficient sodium-ion (Na⁺) insertion. When the precursor material is treated with alkali, a set of chemical reactions occurs, which modifies the carbon structure to provide carbon chains with different length. This improves the performance of sodium-ion batteries that use the hard carbon.

Take NaOH as an example, the addition of NaOH to the carbonaceous precursor leads to a redox reaction wherein carbon (C) is oxidized, promoting the formation of sodium metal (Na), sodium carbonate (Na₂CO₃), and hydrogen gas (H₂). This reaction contributes to the activation of the carbon surface, resulting in enhanced porosity and increased surface area conducive to Na⁺ ion diffusion and electrochemical activity.

Subsequently, the reaction of sodium metal with water, if present, generates additional NaOH and releases hydrogen gas. This step further influences the pore structure, creating an optimal environment that facilitates the insertion and de-insertion of Na⁺ ions during the charging and discharging cycles of the battery.

Through these reactions, the alkali treatment modifies the biomass-derived precursor into a form of hard carbon with a sieving structure that enables the accommodation of Na⁺ ions, leading to improved cycling stability and energy capacity of the sodium-ion battery. The resulting material is ideal use as an anode in energy storage systems, particularly due to the high surface area, ideal pore size distribution, and the presence of functional groups bestowed by the alkali activation process.

The action of the alkali solutions assists in the removal of organic impurities, as well as the etching of the carbon framework, which results in the enlargement or creation of pores that are needed for ion transport. The selection of the alkali is based on the desired chemical affinity and the specific characteristics of the precursor being used.

The selection of the alkali solution is not limited to sodium hydroxide (NaOH) but can be chosen from other suitable solutions such as potassium hydroxide (KOH), lithium hydroxide (LiOH) and ammonia (NH₄OH). Each of these alkali solutions has unique properties that can impact the activation and pore development processes of the precursor material, hence affecting the structure and performance of the final hard carbon product. While NaOH is effective in enhancing pore structures and improving the accessibility of sodium ions, KOH is known for its ability to create larger pore volumes, whereas LiOH and NH₄OH might incite different pore development dynamics owing to the ionic radius.

The rinsing not only cleanses the precursor but also contributes to the chemical activation of the carbon structure. Once the pre-carbonized precursor has been sufficiently rinsed, it is then subjected to further heat treatment under an inert atmosphere, such as nitrogen (N₂) and argon (Ar) at a controlled heating rate, eventually reaching a targeted high temperature for the development of the desired hard carbon structure.

The temperature elevation to 900-1400° C. promotes the transformation of the activated precursor into the final form of hard carbon. It is at this stage that the unique pore structure becomes fixed, and the material acquires the high surface area and porosity necessary for effective sodium-ion insertion. The resulting substance, consisting of closed-pore hard carbon with pores smaller than 10 nm, is ideal for use as an anode material in sodium-ion batteries since it offers optimal pathways for ion transport, leading to enhanced battery performance in terms of energy density, lifespan, and charging rates. The sieving process serves to select particles of a specific size range, ensuring consistency in the material. The sieving process also segregates closed-pore hard carbon particles that possess the ideal pore size, thereby ensuring high efficiency in Na⁺ ion insertion and extraction during battery operation.

The second calcination step is preferably carried out in an inert atmosphere, such as nitrogen (N₂), argon (Ar), etc., to prevent undesirable oxidation of the carbon material. The controlled processing environment and the specific temperature regimen ensures that the developed hard carbon presents a desirable pore distribution and integrity, ensuring consistency in electrochemical performance when deployed within sodium-ion batteries.

This method of preparing the powdered and sequentially calcinated hard carbon is conducive for bulk synthesis, enabling large-scale production of anode material. This scalability is a significant consideration for the widespread adoption of sodium-ion battery technology in various applications, ranging from portable electronics to grid-scale energy storage systems. Moreover, the use of biomass as a starting material leverages renewable resources, hence contributing to the sustainability of the overall manufacturing process.

The temperature for this second calcination is significantly higher than the initial calcination and is adjusted to lie within the range of 900° C. to 1400° C. The increased temperature during re-calcination promotes the complete carbonization of the precursor material, resulting in the formation of hard carbon. The high-temperature treatment promotes the evolution of non-carbon atoms and supports the development of a graphitic-like structure, which is needed for achieving the desired electrical conductivity and crystallinity. It is during this phase that the desirable sieving closed-pore structure is formed. These closed pores are critical for the efficacy of the hard carbon when employed as an anode material, as they regulate the interaction between the hard carbon structure and the sodium ions during the battery's charge and discharge cycles. The produced hard carbon with such refined microporosity demonstrates improved electrochemical performance when subsequently integrated into sodium-ion batteries, offering advantages in terms of energy storage capability, cycle life, and rate performance.

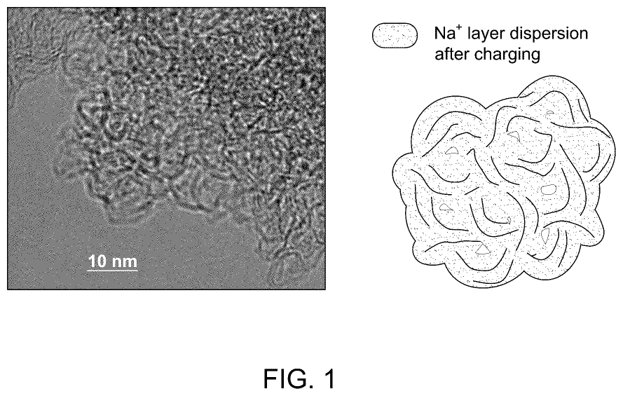

In this patent, the methodology ensures the formation of a hard carbon structure with specific sieving closed-pore characteristics, making it suitable for use as an anode material in sodium-ion batteries. The diameter of sodium (Na⁺) is higher than lithium (Li⁺). Thus, the Na⁺ cannot be inserted into the graphite anode. Because of the short-disordered structure, the Na⁺ ions can be: i) adsorbed on the surface of the hard carbon; ii) inserted into the hard carbon layers; and iii) aggregated inside closed-pore structure. Therefore, the Na⁺ amount is increased on the anode and generates positive impacts on the electrochemical property of SIBs. The TEM structure of the hard carbon is shown in FIG. 1, and the sodium layer dispersion after charging is also illustrated in FIG. 1 where the Na⁺ is (1) absorbed on the surface, (2) asserted into the layer, and (3) aggregated in the pores. The resulting structure has high coulombic efficiency, high specific capacity, resulting in increased battery life cycle. The sieved hard carbon is characterized by its uniformity in terms of pore distribution, which directly correlates to the efficiency of Na⁺ ion insertion during the battery charging process. This efficiency is particularly significant as the uniform and optimal pore size of less than 10 nm allows for improved ionic conductivity and charge-discharge cycle stability, thereby enhancing the energy storage and lifespan of the battery cells.

The sieving structure, which has undergone the process of selecting for pore sizes less than 10 nm, is visualized using a transmission electron microscope (TEM) image in FIG. 1. The obtained image reveals the intricate details of the material's microstructure and provides direct evidence of the successful separation of closed-pore hard carbon particles based on their pore size. In this image, one can clearly discern the uniformity and distribution of pores within the carbon matrix, characteristic of the sieving structure.

The closed-pore hard carbon structure is an integral component of the sodium-ion battery anode material. The closed pores provide discrete sites for sodium-ion insertion and storage within the hard carbon material. The confinement of Na⁺ ions in these pores facilitates efficient charge-discharge cycling by offering a stable environment that reduces the likelihood of detrimental reactions with electrolytes or other components of the battery. The sieve structure generated through the sieving step ensures that the majority of the pores are sized below 10 nm. The diagrams, therefore, display a hard carbon material where a significant portion of the pores fall within this optimal size range, which is particularly advantageous for the kinetics of Na⁺ ion insertion and de-insertion during battery operation. Additionally, the diagrams delineate the result of the chemical and thermal treatments, including the use of NaOH which yields the chemical reaction NaOH+C→Na+Na₂CO₃+H₂, and Na+H₂O→NaOH. These treatments contribute to developing the carbon's porosity and enhancing its electrochemically active surface area.

In one aspect concerning the Na⁺ ion insertion, it becomes evident that the sieving structure developed from the sieved closed-pore hard carbon enhances the electrochemical performance of sodium-ion batteries. The sieving structure is designed to selectively permit the insertion of Na⁺ ions during the charging process of the battery. The controlled insertion of Na⁺ ions into finely-tuned pore sizes, which are less than 10 nm in one example, ensures efficient use of the available electrochemical surface within the sieving structure and maximizes charge storage capacity.

Once inserted, Na⁺ ions are situated within the pores of the sieving structure, providing a stable and efficient pathway for ion transfer during battery operation. The sieving structure with inserted Na⁺ ions demonstrate a significant increase in performance when employed as an anode material in sodium-ion batteries, exhibiting superior charge capacity and enhanced cycle stability.

The preparation of the hard carbon begins with selecting a suitable biomass mixture. This mixture is derived from organic matter that is carbonaceous in nature, capable of being transformed through thermal decomposition into a solid carbon form. To ensure the quality and consistency of the pore structure, the biomass is subjected to a calcination process. The initial calcination takes place at a temperature of around 300-600° C., during which volatile components of the biomass are expelled, leaving behind a carbon-rich residue.

Following the initial calcination, the resultant carbonaceous material is mixed with an alkaline solution. The chemical reactions that occur during this stage not only activate the carbon material but also play a large role in pore development. Specifically, the interaction with alkali promotes the opening of pores within the carbon structure, prepping the material for subsequent processing.

During the washing step, impurities that may have been introduced during the calcination process or inherent from the biomass precursor are removed, which can otherwise negatively impact the electrochemical performance of the hard carbon when utilized as an anode material in sodium-ion batteries.

After washing and further cleaning, the carbon material undergoes a second calcination step, this time at a significantly higher temperature of 900-1400° C. It is during this re-calcination that the material consolidates into a form of hard carbon. Simultaneously, this treatment fine-tunes the pore structure, leading to the creation of closed pores that exhibit a distribution with a median size smaller than the exemplary 10 nm.

Upon completion of the high-temperature treatment, the hard carbon is then sieved, a process that serves to isolate the fraction of the material possessing the desired pore size. This is a critical step, ensuring that the final product will have a consistent and uniform pore structure that can facilitate the targeted Na⁺ ion transport dynamics.

Initially, the biomass mixture acts as a precursor to the closed-pore hard carbon, undergoing a calcination process at a reference temperature of 300-600° C. This stage eliminates volatile compounds and begins the carbonization of the biomass. The precursor is then subjected to an alkali treatment, which creates an activated carbon structure with the potential for desired pore formation. To further refine the carbon structure, a re-calcination process takes place at a higher reference temperature of 900-1400° C. This step enhances the carbon matrix with the desirable traits for energy storage, namely, electrical conductivity and ion accessibility.

The thermal treatment step at 900-1400° C. engenders the elimination of any remaining non-carbon elements and promotes the growth of graphitic structures conducive to Na⁺ ion storage. Furthermore, the rigor of this high-temperature regime assists in attaining a desirable level of graphitization and porosity, which are imperative characteristics for efficient ion transport and intercalation. The employment of an inert atmosphere, typically nitrogen, during the re-calcination safeguards the carbonaceous materials from oxidation and facilitates the development of a porous network needed for the targeted application.

During the pre-carbonization stage, the temperature should stay below 600° C. to prevent excessive ash formation which could diminish the quality of the final carbon product. Conversely, the temperature is kept above 300° C. to ensure adequate thermal breakdown of the biomass components. This controlled thermal treatment is needed in breaking down the lignocellulosic structure and other organic compounds present in the biomass mixture, giving rise to a pre-carbonized material that possesses a porous matrix necessary for the subsequent activation and development of the final hard carbon structure.

Following the pre-carbonization step, the resultant semi-carbonized biomass mixture is then immersed in a alkali solution, initiating a chemical activation process. The alkali not only cleanses the carbonized material of residual impurities but also creates additional porosity by etching away at the carbon framework. The reaction between alkali and the carbon elements leads to the formation of carbonate salt and hydrogen gas, further influencing the textural properties of the material.

The activated material is then subject to a second phase of carbonization, referred to as re-calcination, where it is heated to a temperature of approximately 900-1400° C. It is during this stage that the already developed porous carbon structure is transformed into a tightly-packed arrangement of graphene-like layers, known as hard carbon. This re-calcination at a higher temperature purifies the carbonaceous material by removing any remaining non-carbon elements and enhances electrical conductivity needed for battery anodes.

The process enables narrow pore size distribution to be achieved, primarily featuring pores smaller than 10 nm in one case. This small pore size facilitates the insertion and de-insertion of sodium ions during the charge and discharge cycles of the battery. The sieving of the hard carbon to achieve this fine pore distribution involves mechanical separation techniques, capitalizing on the size difference between the desired porosity and larger, unusable pore structures.

Finally, the sieved hard carbon, with its finely-tuned microstructure, is incorporated into a sodium-ion battery. This hard carbon serves as the anode where the intercalation of sodium ions occurs. The compact pore structure not only allows for efficient sodium-ion transport but also enhances the overall energy density and charge-discharge rates of the battery. This innovative approach combines sustainable raw materials with precise thermal and chemical treatments, culminating in an advanced energy storage solution that meets the growing needs for renewable and high-performance battery technology.

Without alkali washing, soft and hard carbon mixture can arise. Also, when re-calcination temperature is higher than 1400° C., glassy carbon would be obtained.

During the calcination process, and the subsequent re-calcination step. The majority of these trace impurities are reduced or eliminated. The elevated temperatures cause the volatilization and decomposition of many organic compounds and the potential transformation or oxidation of inorganic materials to form ash. This ash can be removed from the final product through various purification methods such as washing, filtering, or acid treatment.

The precursor, after undergoing the initial heat treatment, is subjected to the chemical reactions with alkali which serves a dual purpose: it contributes to the activation of the carbon structure, facilitating the creation of porosity, and it also aids in the purification process by reacting with certain impurities to form soluble salts that can be washed away.

One or more trace impurities are commonly found in natural sources of biomass, and these may include, but are not limited to, potassium ions (K⁺), calcium ions (Ca²⁺), and magnesium ions (Mg²⁺). The presence of these impurities can potentially influence the electrochemical characteristics of the hard carbon when applied as an anode material in sodium-ion batteries.

Potassium ions (K⁺) may be present as a result of the biomass composition or as remnants from processing chemicals used during the extraction and purification of the carbon material. These ions can occupy active sites within the carbon lattice or reside within the micropores, potentially affecting the movement of Na⁺ ions and thus the storage capacity.

Similarly, calcium ions (Ca²⁺) and magnesium ions (Mg²⁺) can be found integrated into the carbon structure. These multivalent impurities might affect the electrical conductivity and contribute to variations in pore structure due to their larger ionic size and possible interactions with the carbon matrices.

While these impurities are trace in nature and constitute only a small fraction of the overall composition of the hard carbon, they can affect the overall performance of the material. Therefore, during the manufacturing process, steps may be taken to either reduce the concentration of these impurities or to leverage their presence to optimize the electrochemical performance.

Moreover, strategies to mitigate the influence of these trace impurities on the performance of the sodium-ion batteries could include additional purification processes, post-treatment modifications, or incorporation during controlled calcination stages to alter their state, distribution, or interaction with the Na⁺ ions.

In one example, the removal of impurities is achieved by first washing the biomass mixture with an acidic solution. This acidic solution has a pH value carefully maintained between 3 and 6, ensuring that it is sufficiently acidic to dissolve and remove various impurities such as minerals, inorganic salts, and other non-carbonaceous components that are present within the biomass. The chosen pH range is critical to effectively purge the biomass of contaminants without causing excessive degradation of the organic material that is needed for the subsequent carbonization processes.

In another embodiment, the washing procedure is conducted for a period ranging from 2 to 10 hours, depending on the type and level of impurities present in the biomass. This duration is selected to optimize the effectiveness of the acid wash while minimizing the risk of damaging the integrity of the carbon precursors within the biomass. Complete immersion of the biomass mixture in the acidic solution during this time allows for thorough interaction between the acid and the impurities, thus enhancing the overall cleansing action.

Following the acid wash, the biomass mixture undergoes a secondary washing step with water. This wash aims to remove the one or more acids that have been applied during the impurity removal process. It is imperative to conduct this step with care to ensure that all traces of the acidic solution are eliminated from the biomass mixture. The presence of residual acids could interfere with downstream processes, such as calcination, and negatively affect the properties of the developed hard carbon material.

The water used for washing is typically at or near neutral pH, to counteract the acidity from the previous cleaning step. The biomass is thoroughly rinsed to ensure that no acidic remnants are retained. The washing with water not only neutralizes the biomass but also serves to further cleanse the material of any soluble impurities that may have been loosened by the acid wash but not wholly dissolved.

Once the washing steps are completed, the biomass mixture is dried to remove the added moisture. The drying step serves to prepare the biomass for the high-temperature treatments that will follow, such as calcination and re-calcination, where temperatures of 300-600° C. and 900-1400° C. are employed to transform the biomass into a structured hard carbon material suitable for use in sodium-ion batteries.

Through these cleaning processes, the biomass mixture is conditioned to yield a precursor that is highly pure and conducive to producing a high-quality hard carbon material, featuring a controlled microstructure with closed pores that are ideal for housing Na⁺ ions during the operation of sodium-ion batteries.

One alternative embodiment uses an acidic solution to the treatment and optimization of the material's porosity and chemical properties. The acidic solution consists of one or more acids selected from the group comprising nitric acid (HNO₃), hydrochloric acid (HCl), acetic acid (CH₃COOH), sulfuric acid (H₂SO₄), and phosphate acid (H₃PO₄). This acidic solution serves multiple purposes in the treatment of the biomass precursor and the resulting hard carbon. Firstly, it acts as a cleansing agent, removing impurities and potentially catalyzing reactions that could impede the performance of the hard carbon as an electrode material. Typically, the use of the acidic solution is involved in an acid washing step, whereby the biomass mixture is submerged within the acidic medium. The selection of the acid or combination of acids depends on the desired chemical reactivity and the nature of the biomass utilized. The reaction with nitric acid often contributes to the introduction of nitrogen-doped sites within the carbon matrix, which can potentially enhance electronic conductivity and provide active sites for sodium-ion storage. Hydrochloric acid treatment is known to facilitate the removal of metallic impurities and assists in the opening of the carbon pore structure. Acetic acid, due to its relatively mild acidity, is used to modify the surface chemistry without overly etching the carbon framework. Lastly, sulfuric acid is known for its strong oxidizing capacity and can be employed to insert sulfonic acid groups onto the carbon surface, thereby increasing the hydrophilicity and possibly the ionic conductivity of the material. During the process of preparing the hard carbon, the biomass mixture is subjected to these acids under controlled conditions, which may vary in concentration, temperature, and duration of exposure depending on the desired properties of the final product. After the acid treatment, the mixture is thoroughly washed to remove residual acids and by-products. A subsequent calcination step is applied, which aids in the development of a stable carbonaceous structure, often resulting in the after mentioned sieving structure characterized by a specific pore size that facilitates efficient sodium-ion insertion and extraction during the operation of the battery. The sieving structure obtained through this method can be optimized for the role of the anode in a sodium-ion battery by selectively capturing the hard carbon particles with desired pore sizes. The process of alkali treatment, calcination, and re-calcination ensures that the carbon material exhibits suitable electrical conductivity and stability to cycle sodium ions effectively. The integration of the sieving structure with inserted Na⁺ ions form a robust and efficient electrode for sodium-ion batteries, with the potential to deliver high energy density, long cycle life, and cost-effectiveness due to the use of abundant starting materials and scalable manufacturing processes.

Moreover, the described method supports sustainable manufacturing practices as biomass, a renewable resource, is employed as the carbon source. The transformation of this raw material into an advanced energy storage solution is especially significant given the ongoing shift toward renewable energy systems and the necessity for compatible energy storage technologies.

The pre-carbonized precursor can be subjected to a washing step with water. The washing step removes any loose dust and particulate matter that has not become chemically bonded to the precursor material during the pre-carbonization process. The process can involve agitation or sonication to enhance the cleaning action, followed by a filtration or decantation step to separate the solid carbonaceous material from the removed particulates suspended in the wash water.

Once the pre-carbonized precursor has been thoroughly washed, it is exposed to rinsing with an alkali solution. The alkali treatment involves the use of the KOH, NaOH, LiOH, and NH₄OH solutions, which reacts with the carbonaceous material. This step is needed, as it promotes the opening of the pores within the pre-carbonized structure, thereby facilitating the development of a network of accessible channels and cavities within the carbon matrix. The alkali rinsing not only aids in the functionalization of the carbon surface to improve its reactivity but also plays a significant role in pore development.

The rinsing with the alkali solution is carried out under controlled conditions to ensure that the interaction between the alkali and the pre-carbonized precursor is sufficient to open up pores without damaging the overall structure of the carbon matrix. Parameters such as the concentration of the alkali solution, the contact time between the alkali and the precursor are carefully optimized to produce the desired pore size and distribution within the hard carbon that will be produced in subsequent steps.

Following the alkali treatment, the precursor may undergo additional rinsing steps to remove any excess alkali as well as any salts formed as a result of the chemical reactions during the alkali treatment phase. The resultant hard carbon is expected to exhibit superior performance when utilized as an anode material in sodium-ion batteries due to its optimized structure for Na⁺ ion insertion and storage.

In the production of the hard carbon composite, a biomass mixture is utilized as the primary source of carbon. This biomass mixture may be any kind of carbon-rich organic material that can serve as a precursor in the pyrolysis process. The choice of biomass affects the characteristics of the final hard carbon product.

The precursor is treated through a calcination step under nitrogen atmosphere, which is performed by gradually increasing the temperature to 300-600° C. at a rate of 2-10° C./min and maintaining the temperature for 2-10 hours. This temperature is chosen carefully to achieve initial carbonization while preserving the structural integrity of the biomass.

The electrochemical property of the hard carbon is further improved by adjusting the sodium-ion insertion capabilities. This is achieved by modulating the pore size distribution and ensuring that the size of the pores is ideal for the insertion of Na⁺ or Li⁺ ions. During the charging of the battery, these ions are inserted into the pores of the hard carbon, and during discharging, the ions are extracted, which results in the flow of current in the battery. The uniformity in pore size achieved through sieving allows for a more consistent and efficient insertion and extraction process, leading to a more stable battery with a higher energy capacity.

The hard carbon composite is prepared through a meticulous process of calcination, washing, re-calcination, and sieving to achieve desirable electrochemical properties for use in energy storage systems. The characteristics of the hard carbon, such as the specific pore structure tailored for ion insertion, provide an improved anode material for the next generation of lithium-ion and sodium-ion batteries. This enhanced performance results from the controlled microstructure, obtained from a sustainable biomass source, which leads to better ion storage capacity and the overall efficiency of the battery.

The process further includes a washing step for the carbon powder precursor. After the initial calcination step at a temperature denoted by 300-600° C., the carbon powder precursor obtained from the biomass mixture is then purified through a washing procedure. This washing is executed with water, ensuring the removal of any soluble impurities, non-carbon elements, and ash content that may be present within the precursor material. Washing with water not only aids in purifying the carbonized product but also helps to expose and widen the pore structures, which are critical for the subsequent alkali treatment.

Subsequent to the washing with water, the now cleaner and porous carbon powder is subjected to the alkali treatment as mentioned earlier. The alkaline environment create a network of more accessible channels within the carbon matrix. This chemical activation process promotes an increase in specific surface area, a feature desired for enhanced electrochemical performance.

The washed and activated carbon powder is then directed to further thermal treatment wherein it is subjected to a temperature of 900-1400° C. under an inert atmosphere. The purpose of this high-temperature treatment, also referred to as re-calcination, is to improve the structural integrity of the hard carbon. This step contributes to the electrical conductivity of the final product.

The alkali treatment is carefully conducted by immersing the carbon powder in an alkaline solution with a concentration ranging from 0.05 to 1.0 mol/L. The precise alkali concentration is chosen based on the desired level of porosity and the resultant electrochemical properties required for the specific application. The immersion is maintained for a duration of between 2 to 10 hours, a time frame selected to allow for adequate interaction between alkali and the carbon powder. During this period, alkali acts on the carbon material, etching away at specific sites and enlarging the interlayer spaces within the carbon domains. This etching not only increases the pore volume but also enhances the accessibility of the pores, making them more amenable to sodium ion insertion.

With the increased layer distance, the resultant pore structures exhibit improved ion diffusion dynamics which directly correlates with heightened battery performance. The strategic manipulation of layer distances and pore sizes aims at achieving a delicate balance between structural stability and ion transport efficiency. Consequently, a carbon structure with increased interlayer spacing provides a considerable advantage for energy storage in sodium-ion battery systems.

Following the alkali treatment, the carbon material is thoroughly washed to remove any residual alkali that might have adhered to the surface. This washing step ensures that the integrity of the newly formed pore structures is not compromised by remnants of the treatment reagent. Thereafter, the carbon powder is dried to remove moisture that could potentially affect the measurement of the layer distances as well as the performance of the material in subsequent battery assembly and testing processes.

It is through the effective control of this treatment with alkali that a tailored porosity of the carbon material can be actualized, fostering the development of high-performance hard carbon anodes that are needed for advanced sodium-ion batteries. This innovative synthesis approach marks a significant enhancement over conventional hard carbon materials, pushing the boundaries of energy density, cycle life, and charging rate capabilities in next-generation sodium-ion batteries.

The treated carbon powder, obtained post-calcination and chemical activation, is subjected to a cleaning process. This is executed by washing the powder with water until the pH of the mixture is neutral at 6.0-8.0. The purpose of this washing step is to remove any residual chemical reagents, particularly the unreacted alkali, and byproducts. Bringing the pH to neutrality is of paramount importance as it indicates that the excess alkali has been fully washed away, leaving behind a pure carbon material devoid of contaminants that could adversely affect the performance of the battery. This neutral pH is also indicative of a stable surface chemistry which is needed for the consistent electrochemical behavior of the hard carbon when used as an anode material in sodium-ion batteries. The resulting clean and neutral pH carbon powder exhibits a desirable microstructural architecture that promotes the efficient intercalation and deintercalation of sodium ions during the charge and discharge cycles of a battery. This process step is critical in ensuring that the physical and electrochemical properties of the hard carbon are maintained at optimum levels for subsequent use in energy storage devices. After the washing procedure, the cleaned carbon powder is dried at a suitable temperature to remove any remaining moisture, which could potentially interfere with the material's electrical conductivity and ion transport properties. Following the drying process, the carbon material is now ready for further characterization or for direct incorporation into a battery cell as the anode component, where its performance can be evaluated in terms of capacity, cycle life, and overall efficiency in a sodium-ion battery system.

The process for the production of hard carbon for sodium-ion batteries includes the step of rinsing the pre-carbonized precursor. After the biomass mixture has undergone initial calcination under inert gas to reach a temperature of 300-600° C. for a period of 2-10 hours, creating the pre-carbonized precursor, it is subjected to a thorough rinsing process. This rinsing is performed using an alkali solution. The concentration of the alkali solution is carefully controlled to fall within a specified range, namely between 0.05 to 1.0 mol/L. The purpose of the alkali rinse is to effectively remove impurities and any remaining volatile matter that may be present within the pre-carbonized precursor. This step is critical as it influences the structural characteristics of the resulting hard carbon.

The duration of the alkali solution rinse is also a variable parameter and is maintained for a time frame ranging from 2 to 10 hours. The selection of the time period for rinsing is based upon the desired pore structure and chemical purity of the hard carbon. Extended rinsing times may lead to greater activation of the carbon structure, while shorter durations may be sufficient for certain precursor compositions and desired pore distributions.

Following the alkali solution rinse, the pre-carbonized precursor undergoes an additional washing process with water. The washing with water is continued until the pH of the solution reaches approximately neutral (pH from 6.0 to 8.0). The water wash ensures the removal of any residual alkali that may remain from the previous process step. It also aids in neutralizing the carbon material, rendering it safe for handling and further processing. This thorough washing step is needed to prevent any undesired chemical reactions during subsequent heat treatments and to ensure the purity of the hard carbon.

The pre-treated precursor, after being thoroughly rinsed and washed, is then subjected to calcination at higher temperatures of 900-1400° C., which aids in the formation of high-quality hard carbon. This hard carbon possesses an optimized closed-pore structure that is ideal for the insertion of sodium ions when used as an anode material in sodium-ion batteries. Through this systematic and precise treatment process, the precursor is transformed into an efficient and effective material with great potential for energy storage applications. The end result is a hard carbon anode material that can enhance the performance and longevity of sodium-ion batteries, thereby contributing to more sustainable and reliable energy storage solutions.

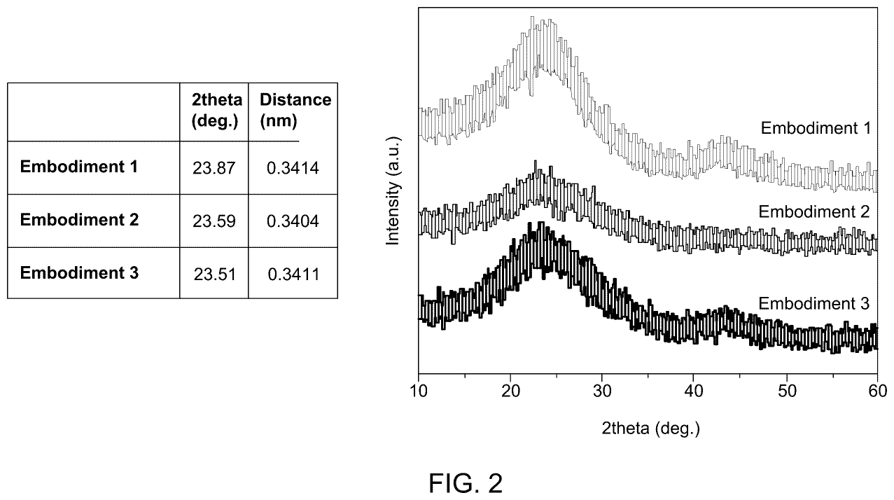

FIG. 2 shows exemplary XRD patterns of three hard carbon samples produced using the instant method. The amorphous structures are obtained. There are no peaks belong to graphite indicating the successful synthesis of hard carbon. The peak positions are between 23.5 to 23.9°, which indicates a wide layer distance compared to graphite. The XRD pattern in FIG. 2 shows two broad peaks, which are characteristic of hard carbon. The absence of peaks from graphite indicates that the samples are highly amorphous. The first peak, centered at around 23.5 to 23.9°, is attributed to the (002) plane of hard carbon. The distance of the carbon layer is calculated to be 0.3414, 0.3404 and 0.3411 nm, which indicates a wide layer distance compared to graphite. The second peak, centered at around 44.0°, is attributed to the (101) plane of hard carbon. The intensity of the (002) peak is typically greater than the intensity of the (101) peak.

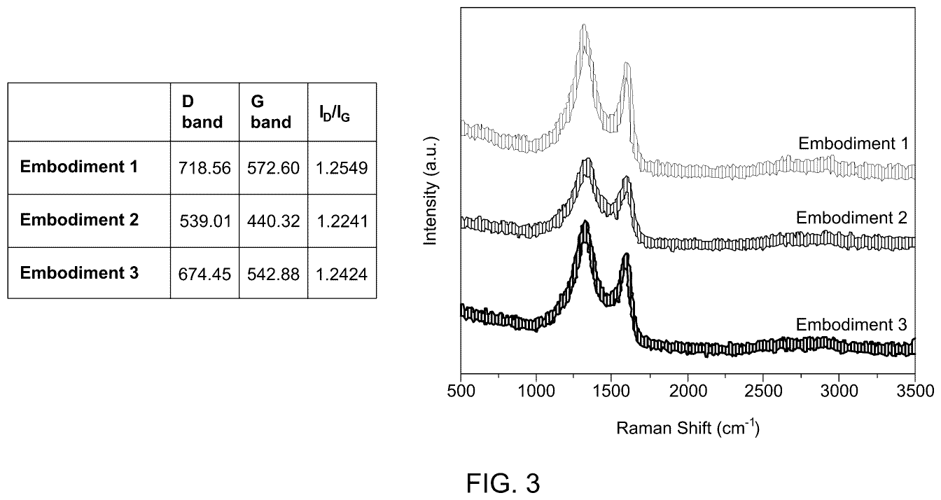

FIG. 3 shows exemplary Raman spectra patterns for three hard carbon samples produced using the instant method. The Raman spectra of the three hard carbon embodiments show two main features: a broad D band at around 1350 cm-1 and a sharp G band at around 1580 cm-1. The D band is attributed to the presence of disorder and defects in the carbon structure, while the G band is attributed to the in-plane stretching vibration of sp²-bonded carbon atoms. The intensity ratio of the D and G bands, ID/IG, is a measure of the degree of disorder in the carbon structure. A higher ID/IG ratio indicates a higher degree of disorder. The Ip/IG ratios of embodiment 1, embodiment 2 and embodiment 3 are 1.2549, 1.2241 and 1.2424, respectively. The ratio is constantly higher than 1.000 confirming the hard carbon disorder short chain structure. The degree of disorder in the carbon structure is known to affect the performance of hard carbon electrodes. Hard carbon electrodes with a higher degree of disorder tend to have higher specific capacity and better rate capability.

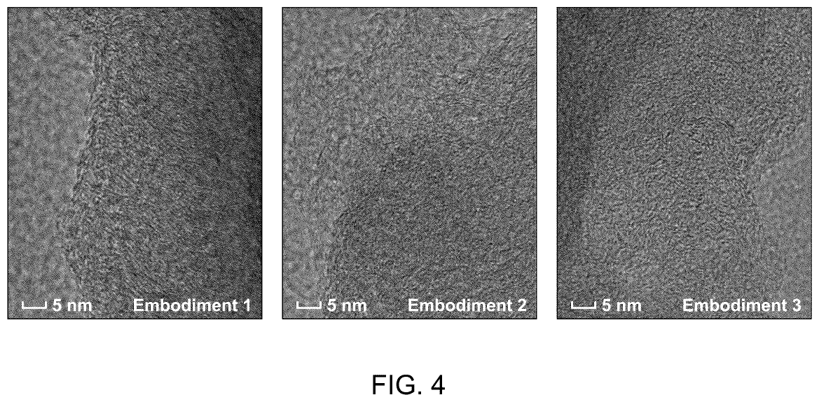

FIG. 4 shows exemplary TEM images for the three hard carbon samples produced using the instant method. The method produces a sieving structure depicted through imaging techniques such as TEM, providing visual confirmation of the nanoscale pore size distribution within the hard carbon. The resulting hard carbon material with the sieving structure supports the ready insertion of Na⁺ ions upon charging of the battery. This feature is useful for high-efficiency sodium-ion batteries, where a reversible and rapid exchange of ions between the anode and cathode is required during charging and discharging cycles. As can be seen in FIG. 4, the obtained hard carbon shows short, disordered carbon chains. The short chains construct closed pores structure with increased layer distance and spaces for Na⁺ insertion and storage.

The SIB anode in FIG. 1 features closed pores that are needed for efficient sodium ion storage, acting as the primary microstructure for accommodating Na⁺ ions. The closed pores create a sieving effect that prevents the formation of a solid electrolyte interphase (SEI) inside the nanopores, which is beneficial for battery performance. The pore size and distribution are needed, in this example improving reversible capacity and initial Coulombic efficiency (ICE), while an upper limit of pore body diameter smaller than 10 nm ensures the reversibility of the plateau capacity.

SIB cathodes can use materials such as sodium metal oxides or phosphates. The electrolyte in these batteries is a sodium salt dissolved in an organic solvent, and the anode composed of hard carbon characterized by sieving closed-pore structure helps prevent excessive electrolyte decomposition inside the pores. Sodium ion storage in hard carbon anodes occurs through multiple mechanisms, including insertion between carbon layers, adsorption on surfaces, and pore filling.

There are several performance advantages associated with this process. Hard carbon anodes with optimized pore structures can achieve plateau capacities in various implementations of up to 300 mAh·g⁻¹ and capacities of 382 mAh·g⁻¹. The sieving closed-pore structure can significantly enhance the initial Coulombic efficiency, with some designs reaching up to ˜85%. Additionally, the closed pores improve the capacity from the low-voltage platform and reduce electrolyte decomposition by minimizing undesired SEI formation inside the pores. By carefully controlling the pore structure, microcrystalline structure, and defects in hard carbon anodes, researchers aim to further improve the electrochemical performance of SIBs, making them a viable and cost-effective alternative to lithium-ion batteries.

Various electrolytes can be used in the SIB. Organic Liquid Electrolyte with sodium salts dissolved in organic solvents can be used. NaClO₄-based organic liquid electrolytes are widely used due to their good compatibility with common cathode materials. Solid electrolytes can also be used and include materials like Sodium Super Ionic Conductor (NASICON), which offer high ionic conductivity and are non-flammable, providing enhanced safety compared to liquid electrolytes. The electrolyte serves as a medium for sodium ions to move between the cathode and anode during charge and discharge cycles. It also participates in the formation of the solid electrolyte interphase (SEI) on the anode and the cathodic electrolyte interphase (CEI) on the cathode, which are needed for the battery's electrochemical performance.

The SIBs can utilize various biomass materials as the starting point, including but not limited to organic farm materials and cotton. This raw material can be processed under controlled conditions, such as a gradual temperature increase in an inert atmosphere followed by washing with a alkali solution and additional heat treatment. Such meticulous control over the production process ensures the development of hard carbon anodes that are well-suited for the next generation of energy storage systems.

The biomass mixture contains one or more trace impurities which inherently exist due to the nature of the biomass sources from which the mixture is derived. The trace impurities commonly associated with biomass may include, but are not limited to, inorganic salts, metals, and non-carbon organic compounds that are present in minute quantities. These impurities can originate from the soil, water, or air that was in contact with the biomass during its growth and harvesting stages. The instant method enables the production of sieved closed-pore hard carbon which is specifically advantageous for use as anode material in lithium-ion and sodium-ion batteries. The method systematically employs the use of a biomass mixture as the starting material, which offers an environmentally friendly and cost-effective feedstock compared to fossil-fuel derived carbon sources. The biomass mixture is subjected to a calcination process at a temperature of 300-600° C. to initiate the carbonization of the biomass. This is followed by a treatment with NaOH, wherein specific chemical reactions are carried out to activate the carbon structure and increase its porosity. The chemical reactions produce Na and Na₂CO₃ while releasing H₂, and additionally, Na reacts with water to produce further NaOH. Once the re-calcined hard carbon is obtained, it is subjected to a sieving process. This step is critical as it ensures that the final product comprises exclusively those particles that possess an optimal pore size, specifically less than 10 nm. The diminutive size of these pores is instrumental in facilitating the insertion and diffusion of Na⁺ ions during the operation of the battery, which is needed for high efficiency and battery performance. This sieving step not only selects for pore size but also helps in achieving a uniform distribution of pores, which contributes to the homogeneity of the final anode material.

The anode for the SIB includes a hard carbon material characterized by a sieving closed-pore structure with a surface and an inner space, the structure further having a window to receive sodium during charging, wherein the sodium ion passes through the window and absorbs on the surface and occupies the inner space after charging. The anode features closed pores that are needed for efficient sodium ion storage, acting as the primary microstructure for accommodating Na⁺ ions. The closed pores have tightened entrances creating a sieving effect that prevents the formation of a solid electrolyte interphase (SEI) inside the nanopores, which is beneficial for battery performance. The pore size and distribution are needed, with ultra-micropores improving reversible capacity and initial Coulombic efficiency (ICE), while an upper limit of pore body diameter less than 10 nm ensures the reversibility of the plateau capacity. The closed-pore structure not only enhances the reversible capacity but also contributes to a high initial Coulombic efficiency. For example, a closed pore enriched carbon anode can achieve a reversible capacity of 309.3 mAh/g with an initial Coulombic efficiency of 87.8%. The design of these closed pores is needed for optimizing sodium storage, as they provide a stable environment for sodium ions during charge and discharge cycles, improving the overall cycle stability and energy density of the SIB.

The sodium-ion battery includes a cathode; an electrolyte coupled to the cathode; and the above anode coupled to the electrolyte. The anode has the plurality of sieving close-pore structures with a surface and an inner space, the structure further having a window to receive sodium ions, wherein the sodium ion passes through the window and absorbs on the surface and occupies the inner space after charging. The closed pores are characterized by their small entrance size, which creates a sieving effect. This design prevents the formation of a solid electrolyte interphase (SEI) inside the nanopores, a common issue with porous carbons that have larger surface area pores accessible to electrolytes. As a result, sieving carbons exhibit superior electrochemical performance compared to traditional porous carbon materials. For instance, while porous carbons may only achieve a reversible capacity of 39 mAh/g, sieving carbons can reach much higher capacities, such as 328 mAh/g at a current density of 50 mA/g.

There are several performance advantages associated with this design. Hard carbon anodes with optimized pore structures can achieve plateau capacities of in various implementations up to 300 mAh g⁻¹ and reversible capacities of 382 mAh g⁻¹. The sieving closed-pore structure can significantly enhance the initial Coulombic efficiency, with some designs reaching up to 80.21%. Additionally, the closed pores improve the capacity from the low-voltage platform and reduce electrolyte decomposition by minimizing undesired SEI formation inside the pores. By controlling the pore structure, microcrystalline structure, and defects in hard carbon anodes, the electrochemical performance of sodium-ion batteries can be a viable and cost-effective alternative to lithium-ion batteries.

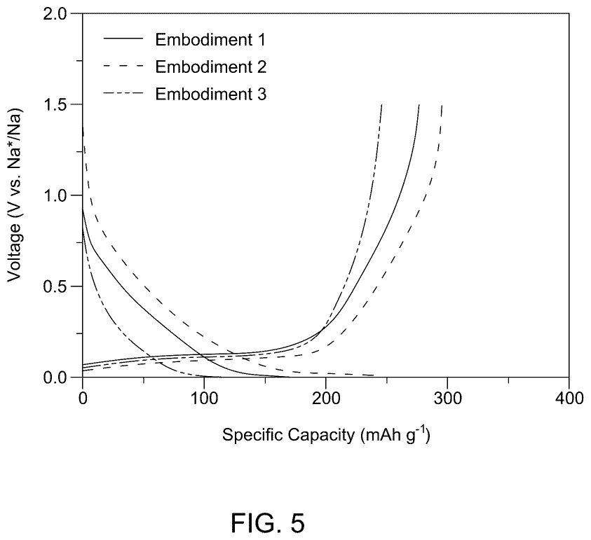

FIG. 5 shows more battery data, specifically the capacity and ICE of embodiment 1, embodiment 2 and embodiment 3. The obtained hard carbon shows a high discharge capacity above 240 mAh/g with ICE above 80%. The data is as follows:

| | Charge Capacity | Discharge Capacity | |
|---|---|---|---|
| | (mAh/g) | (mAh/g) | ICE (%) |
| Embodiment 1 | 321.80 | 276.24 | 85.8 |
| Embodiment 2 | 380.22 | 296.40 | 78.0 |
| Embodiment 3 | 287.30 | 246.33 | 85.7 |

The structure of hard carbon is as follows: Short carbon chain; Highly disordered structure; Long layer distance; and Closed-pore structure. Because of the short-disordered structure, the Na⁺ ions can be adsorbed on the surface of the hard carbon; Inserted into the hard carbon layers; and aggregated inside closed-pore structure. Thus, the Na⁺ amount is increased on the anode and generate positive impacts on the electrochemical property of SIBs.

In one implementation of the processing of the biomass mixture, the pre-carbonized precursor obtained after the first calcination step can be subjected to grinding to produce a fine powder. This grinding can ensure homogeneity in particle size and morphology, as well as to increase the surface area of the precursor material. The increased surface area is critical to the performance of the hard carbon as it can potentially enhance the Na⁺ ion insertion capabilities by providing more accessible active sites for electrochemical reactions. The grinding process is carried out using a suitable grinding apparatus known to those skilled in the art, such as a ball mill, a jet mill, or a mortar and pestle, until the desired powder consistency is achieved. Care is taken to avoid contamination of the precursor material, as impurities could influence the electrochemical properties of the final hard carbon product. Post grinding, the now powdered pre-carbonized precursor, with significantly reduced particle size, is directed to the second calcination step. It is here that the precursor undergoes a rigorous thermal treatment at a temperature of approximately 1300° C., as previously indicated. The transition to high temperatures aids in the expunging of any remaining inorganic content and facilitates the graphitization process. The resulting product from the second calcination is hard carbon with an improved degree of crystallinity, optimizing it for better electroconductivity and mechanical stability. Furthermore, with the NaOH treatment, the smaller particle size resulting from the grinding step allows for a more uniform insertion of Na⁺ ions into the sieving structure of the hard carbon. The sieving structure with Na⁺ ions inserted proves to have enhanced electrical characteristics favorable for use as an anode material in sodium-ion batteries. The sieving structure effectively allows for the selective insertion of Nations, ensuring that the battery operation is efficient and the charging and discharging rates are optimal.

The prepared biomass mixture is subjected to a calcination process at a temperature of 450° C., during which the organic substances within the biomass decompose under the influence of heat in an inert nitrogen atmosphere. This thermal treatment is conducted with a specific heating rate of 5° C./min and maintained for a period of 3 hours, allowing gradual transformation of the biomass into a carbonized state while avoiding abrupt thermal shock that could damage the structural integrity of the material.

Subsequently, to enhance the porosity and activate the resulting carbon, the material is treated with an aqueous solution of NaOH. This alkali treatment reacts with the carbonized biomass, as described by the chemical equation wherein NaOH interacts with carbon to form sodium carbonate and hydrogen gas. This process also helps to widen the pore structure within the carbon matrix, creating a network of channels suitable for ion transport.

Once NaOH treatment is complete, the precursor is subjected to a further increase in temperature, reaching 1300° C., under a nitrogen atmosphere. This re-calcination step serves to stabilize the hard carbon by removing any remaining non-carbon species and aligning the carbon domains to enhance electrical conductivity and structural resilience.

The sieving of the hard carbon selectively removes particles based on pore sizes. It ensures that only those particles with an optimal pore diameter, specifically less than 10 nm, are utilized. These pores are ideal for accommodating Na⁺ ions during the charging process, thereby maximizing the charge storage capacity of the hard carbon.

Finally, the resultant sieving structure with Na⁺ ions inserted exemplifies a material with a high density of accessible active sites for reversible Na⁺ intercalation, a critical attribute for high-performance sodium-ion battery anodes. Through this method, a sustainable and cost-effective pathway is established for converting agricultural waste into valuable components for the growing energy storage market, which is a significant step forward in the development of green technology solutions.

The resulting hard carbon, with its densely populated, uniform, and closed pores of approximately 10 nm, provides a unique structure that maximizes the accessible surface area for Na⁺ ion intercalation while also contributing to a stable and robust electrode material. This architecture contributes to a low strain during charge and discharge cycles, which not only enhances the battery's overall capacity but also its longevity and cycling stability.

Acknowledging the variation in the biomass precursors and the accompanying disparities in the re-calcination outcomes, the process parameters such as temperature hold time and heating rate can be optimized to yield hard carbon with specific microstructural characteristics tailored to the intended electrochemical application. Through this thermal treatment process, the realization of sieved closed-pore hard carbon is achieved, which is subsequently integrated into an anode that offers superior capacity retention and rate performance, addressing the increasingly exigent energy storage requirements.

While specific embodiments and examples of the present invention have been illustrated and described, numerous modifications come to mind without significantly departing from the spirit of the invention, and the scope of protection is only limited by the scope of the accompanying claims.

1. A hard carbon with sieving closed-pore structure, wherein a raw material to prepare the hard carbon is a biomass mixture which comprises 70-90% cellulose, 9-20% hemicellulose and 1-10% lignin, wherein a pore size of the sieving closed-pore structure is smaller than 10 nm.

2. A method for preparing hard carbon of claim 1, comprising: 1) calcining the biomass mixture at a temperature between 300-600° C. to produce a pre-carbonized precursor; 2) rinsing the pre-carbonized precursor with an alkali solution then adjusting the pH to 6.0-8.0; and 3) re-calcining the pre-carbonized precursor at a temperature between 900-1400° C. to produce a sieving closed-pore hard carbon.

3. The method of claim 2, wherein the calcining biomass mixture is performed in an inert atmosphere.

4. The method of claim 2, wherein the temperature of the calcining biomass mixture is between 300-600° C.

5. The method of claim 2, wherein the concentration of the alkali solution to rinse the pre-carbonized precursor is 0.05-1.0 mol/L.

6. The method of claim 2, wherein the alkali solution treatment is 2-10 hours.

7. The method of claim 2, wherein the alkali solution treatment further comprises modulating the pH to 6.0-8.0.

8. An anode for a battery, comprising a hard carbon material characterized by a sieving closed-pore structure.

9. The anode of claim 8, wherein the sieving closed-pore structures are formed by: calcining a biomass mixture having 70-90% cellulose, 9-20% hemicellulose, and 1-10% lignin at a temperature between 300-600° C. to produce a pre-carbonized precursor; rinsing the pre-carbonized precursor with an alkali solution to adjust the pH to 6.0-8.0; and re-calcining the pre-carbonized precursor at a temperature between 900-1400° C. to produce the sieving closed-pore structures.

10. A battery, comprising: a cathode; an electrolyte coupled to the cathode; and an anode coupled to the electrolyte, the anode having sieving close-pore structures.

11. The battery of claim 10, wherein the sieving closed-pore structures are formed by: calcining a biomass mixture at a temperature between 300-600° C. to produce a pre-carbonized precursor; rinsing the pre-carbonized precursor with an alkali solution to adjust the pH to 6.0-8.0; and re-calcining the pre-carbonized precursor at a temperature between 900-1400° C. to produce a sieving closed-pore hard carbon.

12. The battery of claim 11, wherein the biomass mixture comprises 70-90% cellulose, 9-20% hemicellulose, and 1-10% lignin.
